(19) United States
(12) Patent Application Publication
(10) Pub. No.: US 2026/0288137 A1
(43) Pub. Date: Sep. 24, 2026

(54) UNMANNED AERIAL VEHICLE SYSTEM AND METHOD

(71) Applicant: Myriad Technologies Corp., Wilmington, DE (US)

(72) Inventors: Brian N. Davidson, Arlington, VA (US); Sven A. Brueckner, Harrisonburg, VA (US)

(21) Appl. No.: 19/084,313

(22) Filed: Mar. 19, 2025

Related U.S. Application Data
(60) Provisional application No. 63/568,518, filed on Mar. 22, 2024.

(51) Int. Cl. G05D 1/2285; G05D 1/246; G05D 1/617; G05D 101/10; G05D 109/25

(52) U.S. Cl. CPC G05D 1/2285; G05D 1/246; G05D 1/621; G05D 2101/10; G05D 2109/254

(57) ABSTRACT

Unmanned aerial vehicle (UAV) control including: receiving, by a UAV mission controller from a user by way of a user interface of a user device, a natural language mission request concerning a mission for a UAV to be conducted in a given geographic region; obtaining, by the UAV mission controller from a mapping application, textual map data for the given geographic region; obtaining, by the controller, UAV configuration data indicative of capabilities of the UAV; providing, by the controller to a language model (LM), model input data corresponding to the natural language mission request, the textual map data, and the UAV configuration data, the LM adapted to generate, based on the model input data, model mission commands for the mission; receiving, by the controller from the LM, the model mission commands; and sending, by the controller to the UAV, UAV mission commands corresponding to the model mission commands.

### RELATED APPLICATIONS

This application claims benefit of and priority to U.S. Provisional Patent Application No. 63/568,518 titled “UNMANNED AERIAL VEHICLE SYSTEM AND METHOD” and filed March 22, 2024, which is hereby incorporated by reference in its entirety.

### FIELD

Embodiments relate generally to unmanned aerial vehicles (UAVs) and, more particularly, to systems and methods for defining and controlling operations of UAVs.

### BACKGROUND

Unmanned aerial vehicles (UAVs), commonly known as drones, have evolved significantly over the years, having applications in various fields, such as surveillance, inspection, logistics, disaster response, and the like. Traditional UAV control systems typically rely on manual remote control, pre-programmed flight paths, or a combination of both. For example, an operator may control a UAV in real-time using a remote control or may define a predefined flight plan that is executed by the UAV. Such implementations can require a great deal of user skill and knowledge, including knowledge of the capabilities of the UAV, as well as knowledge of the geography and environment where the UAV is expected to fly.

### SUMMARY

In some instances, unmanned aerial vehicles (UAVs), or “drones,” operate autonomously. This can include, for example, a UAV executing a predefined mission that includes following a predefined route and completing associated tasks along the route, with little to no human intervention. In such a scenario, a user may determine a mission objective for a UAV, define a mission that includes a route and tasks to complete the objective, and provide the UAV with corresponding mission commands to be executed by the UAV. In turn, the UAV may execute the mission commands (e.g., including flying the route and completing the tasks) to complete the objective of the mission, with little to no further human intervention. For example, where it is desirable to acquire photographs of a given building, an operator may define a mission that includes a route for traveling to and from the location of the building and tasks that include acquiring photographs at the location of the building. Corresponding mission commands may be downloaded to an onboard control system of the UAV, which, in turn, executes the commands, including controlling the UAV to fly the route to the location of the building, acquire photographs of the building via an onboard camera, and fly the route back from the location of the building to a “home” location.

Unfortunately, defining and executing UAV missions can require a great deal of user skill and knowledge. For example, a user defining missions for a UAV may need to have thorough knowledge of capabilities of the UAV and thorough knowledge of the geography where the UAV is expected to fly. This can become overly complex and burdensome for a user as the number and capabilities of UAVs increase, and as routes and tasks become increasingly more complex. For example, to define a mission for a given UAV, a user may need to know what the UAV is (and is not) capable of performing, what commands are understood by the UAV, the geography of an area of a mission, fly/no-fly zones and obstacles in the area, and any variety of variables, such as real-time weather and air traffic in the area, and so forth.

Provided are embodiments for defining and controlling operations of UAVs. In some embodiments, a UAV mission control system is provided that coordinates inputs from users, data sources, and UAVs, and generates corresponding UAV mission commands that are executed by UAVs. In some embodiments, a UAV mission control system includes a UAV controller (e.g., including a UAV control application) that is operable to receive a natural language request from a user for a UAV to execute a mission (e.g., a spoken request of “Fly UAV#1 over the nearest XYZ convenience store and take pictures of the roof of the store and return”), obtain UAV configuration data defining operational characteristics of the UAV for the mission (e.g., to obtain a current location of UAV#1, capabilities of UAV#1, and available commands for UAV#1), employ a mapping application to obtain relevant map data (e.g., to obtain textual map data for a region between a current location of the UAV and the location of the XYZ convenience store), employ a language model (LM) to determine a set of mission commands to execute a mission (e.g., employ a UAV large language model (LLM) to determine mission commands based on the operational characteristics of the UAV, the textual map data, and other relevant data sources, such as weather and aviation reporting services, or the like), and to transmit, to the UAV, a corresponding set of UAV mission commands that are executable to cause the UAV to execute the mission (e.g., providing commands executable to cause the UAV to fly to the location of the nearest XYZ convenience store, acquire photographs of the XYZ convenience store using an onboard camera, and fly home from the location of the XYZ convenience store).

Although certain embodiments are described in the context of missions that involve flying a route and performing a task of acquiring photographs for the purpose of explanation, embodiments may involve any suitable mission operations, such as flying routes to any variety of locations, acquiring data (e.g., surveillance data) from any host of onboard sensors, completing tasks along the route or at given locations, or the like.

Provided in some embodiments is an unmanned aerial vehicle (UAV) system including: a user device including a user interface; and a UAV mission controller; the user device adapted to: receive, from a user, a spoken request including a natural language mission request concerning a mission for a UAV to be conducted in a given geographic region; generate (e.g., which may include determining, collecting, processing or otherwise obtaining) request data corresponding to the natural language mission request; and send, to the UAV mission controller, the request data, the UAV mission controller adapted to: determine, in response to receiving the request data, the given geographic region; send, to a mapping application, a request for textual map data for the given geographic region; receive, from the mapping application, the textual map data for the given geographic region; obtain UAV configuration data indicative of status or capabilities of the UAV; send, to a UAV large language model (LLM), model input data corresponding to the natural language mission request, the textual map data, and the UAV configuration data, the UAV LLM adapted to generate, based on the model input data, model mission commands for the mission; receive, from the UAV LLM, the model mission commands for the mission; determine, based on the model mission commands for the mission, UAV mission commands for the UAV; and send, to the UAV, the UAV mission commands, the UAV adapted to execute the UAV mission commands to conduct the mission.

In some embodiments, the UAV LLM is adapted to request and obtain, from supplemental data sources, supplemental data concerning operation of the UAV in the given geographic region, and the model mission commands for the mission are generated based on the supplemental data.

Provided in some embodiments is an unmanned aerial vehicle (UAV) system including: a UAV mission controller adapted to: receive, from a user by way of a user interface of a user device, a natural language mission request concerning a mission for a UAV to be conducted in a given geographic region; obtain, from a mapping application, textual map data for the given geographic region; obtain UAV configuration data indicative of capabilities of the UAV; provide, to a language model (LM), model input data corresponding to the natural language mission request, the textual map data, and the UAV configuration data, the LM adapted to generate, based on the model input data, model mission commands for the mission; receive, from the LM, the model mission commands for the mission; and send, to the UAV, UAV mission commands corresponding to the model mission commands for the mission.

In some embodiments, the UAV is adapted to execute the UAV mission commands to conduct the mission. In certain embodiments, the LM is adapted to obtain, from supplemental data sources, supplemental data concerning operation of the UAV in the given geographic region, and where the model mission commands for the mission are generated based on the supplemental data. In some embodiments, the supplemental data sources include a weather information service, and the supplemental data includes weather data for the given geographic region. In certain embodiments, the supplemental data sources include a flight information service, and the supplemental data includes flight data for the given geographic region. In some embodiments, the user device includes a location module adapted to determine a location of the user device, where UAV mission controller is further adapted to: obtain device location data corresponding to a location of the user device determined by way of the location module; and determine the given geographic region based on the device location data. In certain embodiments, the UAV mission controller is further adapted to: determine supplemental request data to be provided by the user, and send, to the user device, dialogue response content requesting the supplemental request data, where the user device is adapted to present the dialogue response content by way of the user interface and obtain the supplemental request data by way of the user interface, where the model input data further corresponds to the supplemental request data. In some embodiments, the UAV configuration data includes a UAV command library that defines available commands for the UAV. In certain embodiments, the UAV configuration data includes UAV model information for the UAV.

Provided in some embodiments is a method for unmanned aerial vehicle (UAV) control including: receiving, by a UAV mission controller from a user by way of a user interface of a user device, a natural language mission request concerning a mission for a UAV to be conducted in a given geographic region; obtaining, by the UAV mission controller from a mapping application, textual map data for the given geographic region; obtaining, by the UAV mission controller, UAV configuration data indicative of capabilities of the UAV; providing, by the UAV mission controller to a language model (LM), model input data corresponding to the natural language mission request, the textual map data, and the UAV configuration data, the LM adapted to generate, based on the model input data, flight plans and associated model mission commands for the mission; receiving, by the UAV mission controller from the LM, the model mission commands for the mission; and sending, by the UAV mission controller to the UAV, UAV mission commands corresponding to the model mission commands for the mission.

In some embodiments, the method further including executing, by the UAV, the UAV mission commands to conduct the mission. In certain embodiments, the LM obtains, from supplemental data sources, supplemental data concerning operation of the UAV in the given geographic region, and where the model mission commands for the mission are generated based on the supplemental data. In some embodiments, the supplemental data sources include a weather information service, and the supplemental data includes weather data for the given geographic region. In certain embodiments, the supplemental data sources include a flight information service, and the supplemental data includes flight data for the given geographic region. In some embodiments, the user device includes a location module adapted to determine a location of the user device, the method further including: obtaining, by the UAV mission controller, device location data corresponding to a location of the user device determined by way of the location module; and determining, by the UAV mission controller, the given geographic region based on the device location data. In certain embodiments, the method further including: determining, by the UAV mission controller, supplemental request data to be provided by the user, and sending, by the UAV mission controller to the user device, dialogue response content requesting the supplemental request data, where the user device is adapted to present the dialogue response content by way of the user interface and obtain the supplemental request data by way of the user interface, where the model input data further corresponds to the supplemental request data. In some embodiments, the UAV configuration data includes a UAV command library that defines available commands for the UAV. In certain embodiments, the UAV configuration data includes UAV model information for the UAV.

Provided in some embodiments is a non-transitory computer-readable storage medium including program instructions stored thereon that are executable by a processor to cause the following operations for unmanned aerial vehicle (UAV) control: receiving, by a UAV mission controller from a user by way of a user interface of a user device, a natural language mission request concerning a mission for a UAV to be conducted in a given geographic region; obtaining, by the UAV mission controller from a mapping application, textual map data for the given geographic region; obtaining, by the UAV mission controller, UAV configuration data indicative of capabilities of the UAV; providing, by the UAV mission controller to a language model (LM), model input data corresponding to the natural language mission request, the textual map data, and the UAV configuration data, the LM adapted to generate, based on the model input data, model mission commands for the mission; receiving, by the UAV mission controller from the LM, the model mission commands for the mission; and sending, by the UAV mission controller to the UAV, UAV mission commands corresponding to the model mission commands for the mission.

### BRIEF DESCRIPTION OF THE DRAWINGS

FIG. 1A is a diagram that illustrates a flight environment in accordance with one or more embodiments.

FIG. 1B is a diagram that illustrates aspects of generating mission commands in accordance with one or more embodiments.

FIGS. 2A and 2B are diagrams that illustrate example UAV configuration data in accordance with one or more embodiments.

FIG. 3 is a diagram that illustrates example map data in accordance with one or more embodiments.

FIG. 4 is a diagram that illustrates example UAV mission commands in accordance with one or more embodiments.

FIG. 5 is a flowchart diagram that illustrates a method of defining and implementing a UAV mission in accordance with one or more embodiments.

FIG. 6 is a diagram that illustrates an example computer system in accordance with one or more embodiments.

While this disclosure is susceptible to various modifications and alternative forms, specific example embodiments are shown and described. The drawings may not be to scale. It should be understood that the drawings and the detailed description are not intended to limit the disclosure to the particular form disclosed, but are intended to disclose modifications, equivalents, and alternatives falling within the spirit and scope of the present disclosure as defined by the claims.

### DETAILED DESCRIPTION

Provided are embodiments for defining and controlling operations of UAVs. In some embodiments, a UAV mission control system is provided that coordinates inputs from users, data sources, and UAVs, and generates corresponding UAV mission commands that are executed by UAVs. In some embodiments, a UAV mission control system includes a UAV controller (e.g., including a UAV control application) that is operable to receive a natural language request from a user for a UAV to execute a mission (e.g., a spoken request of “Fly UAV#1 over the nearest XYZ convenience store and take pictures of the roof of the store and return”), obtain UAV configuration data defining operational characteristics of the UAV for the mission (e.g., to obtain a current location of UAV#1, capabilities of UAV#1, and available commands for UAV#1), employ a mapping application to obtain relevant map data (e.g., to obtain textual map data for a region between a current location of the UAV and the location of the XYZ convenience store), employ a language model (LM) to determine a set of mission commands to execute a mission (e.g., employ a UAV large language model (LLM) to determine mission commands based on the operational characteristics of the UAV, the textual map data, and other relevant data sources, such as weather and aviation reporting services, or the like), and to transmit, to the UAV, a corresponding set of UAV mission commands that are executable to cause the UAV to execute the mission (e.g., providing commands executable to cause the UAV to fly to the location of the nearest XYZ convenience store, acquire photographs of the XYZ convenience store using an onboard camera, and fly home from the location of the XYZ convenience store).

Although certain embodiments are described in the context of missions that involve flying a route and performing a task of acquiring photographs for the purpose of explanation, embodiments may involve any suitable mission operations, such as flying routes to any variety of locations, acquiring data from any host of onboard sensors, completing tasks along the route or at given locations, or the like.

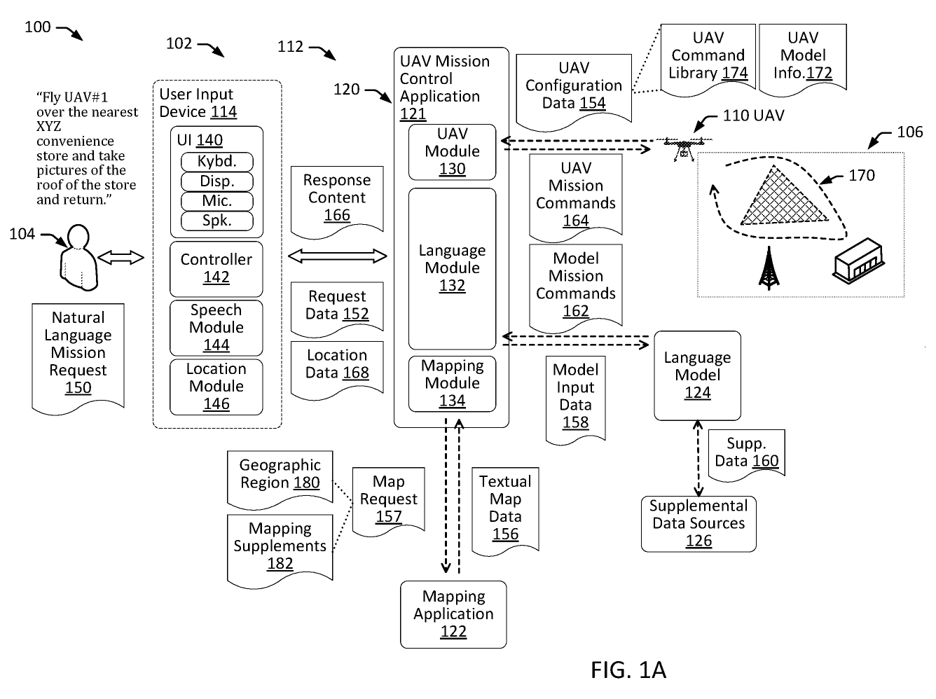

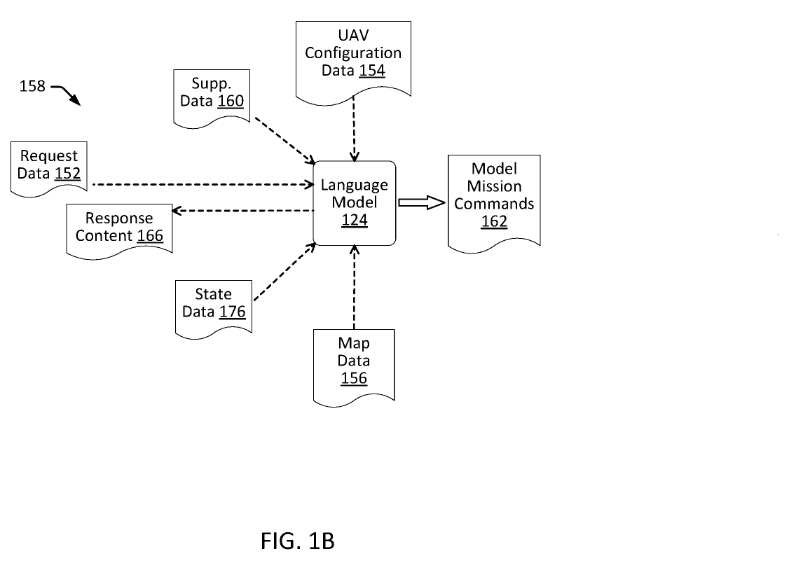

FIG. 1A is a diagram that illustrates a flight environment 100 in accordance with one or more embodiments. In the illustrated embodiment, flight environment 100 includes an unmanned aerial vehicle (UAV) system 102, a user 104, and a flight region 106, which may be a geographic area in which a UAV mission is to be conducted. The UAV system 102 includes a UAV 110, a UAV mission control system 112, and a user input device (“user device”) 114. In the illustrated embodiment the UAV mission control system 112 includes a UAV mission controller 120, a mapping application 122, a language model (LM) 124, and supplemental data sources 126. The UAV mission controller 120 includes a UAV mission control application 121 that includes a UAV module 130, a language module 132, and a mapping module 134. User input device 114 includes a user interface (UI) 140, a controller 142, a speech module 144, and a location module 146.

As described, in some embodiments, user input device 114 is operable to receive, from user 104, a natural language mission request 150 concerning operation of UAV 110 (e.g., a spoken request by user 104 to “Fly UAV#1 over the nearest XYZ convenience store and take pictures of the roof of the store and return”) and provide corresponding request data 152 to UAV mission control application 121 of UAV mission controller 120. UAV mission control application 121 is operable to receive request data 152, obtain UAV configuration data 154 defining operational characteristics of UAV 110 (e.g., obtain a current location of UAV#1, capabilities of UAV#1, and available commands for of UAV#1), employ mapping application 122 to obtain corresponding textual map data 156 (e.g., to obtain, based on a map request 157, textual map data 156 for a region between and including a current location of UAV 110 and the location of the XYZ convenience store), employ LM 124 to determine a set of model mission commands 162 for executing the mission request 150 (e.g., determine a set of model mission commands 162 based on model input data 158 that includes UAV configuration data 154 and map data 156, and supplemental data 160 obtained from supplemental data sources 126), and to transmit, to UAV 110, a corresponding set of UAV mission commands 164 that are executable by the UAV 110 to cause UAV 110 to execute the mission (e.g., program instructions executable to cause UAV 110 to fly along a first portion of a flight path 170 to the location of the nearest XYZ convenience store, acquire photographs of the XYZ convenience store using an onboard camera, and fly home from the location of the XYZ convenience store along a second portion of flight path 170). In some embodiments, UAV mission control application 121 is operable to provide response content 166. Such content may, for example, include feedback or follow-up requests for input that can be presented to user 104 via user input device 114. In some embodiments, request data 152 includes or is accompanied by device, user, or UAV location data 168. Such data may, for example, include information concerning the geographic location of user input device 114, user 104, or UAV 110 that can be employed to determine relevant geographic features of an associated request and mission.

In some embodiments, UAV mission control application 121 is remote from user input device 114. For example, UAV mission control application 121 may be resident on and execute on a remote device, such as a network server or standalone computer in communication with user device 114, mapping application 122, language model 124, and UAV 110. In some embodiments, UAV mission control application 121 integrated with user input device 114. For example, UAV mission control application 121 may be resident on and execute on user input device 114 that is in communication with mapping application 122, language model 124, and UAV 110.

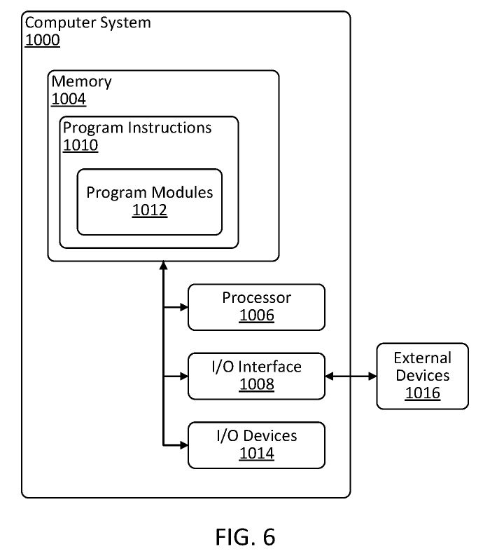

In some embodiments, UAV 110 is an aircraft designed to be operated without any human pilot, crew, or passengers on board. For example, UAV 110 may be an autonomous or remotely piloted aircraft designed for various applications without an onboard human pilot. In some embodiments, UAV 110 supports autonomous flight by way of pre-programmed flight paths and onboard navigation systems. For example, UAV 110 may be operable to execute a set of predefined UAV mission commands 164 that cause UAV 110 to execute a mission (e.g., to cause the UAV to fly to the location of the nearest XYZ convenience store, acquire photographs of the XYZ convenience store using an onboard camera, and fly home from the location of the XYZ convenience store) using onboard navigation systems. In some embodiments, UAV 110 includes a flight system, a UAV controller, a payload (e.g., onboard sensors), or the like. A UAV flight system may include, for example, an airframe (e.g., including wings or other flight control surfaces), a propulsion system (e.g., motors, propellers, or the like), or the like. A UAV controller may include, for example, an onboard processor, memory, or other devices for receiving, storing and executing UAV mission commands (e.g., for controlling aspects of UAV 110, such as the flight system, onboard sensors, or payload, or the like, in accordance UAV mission commands 164). In some embodiments, a UAV controller includes a computer system that is the same or similar to that of computer system 1000 described with regard to at least FIG. 6. A UAV payload may include, for example, sensors, packages, or the like carried onboard UAV 110. Onboard sensors may include, for example, a position sensor (e.g., a global positioning system (GPS) sensor), an image sensor (e.g., a camera), a temperature sensor, or the like that is operable to sense characteristics of UAV 110 or the environment surrounding UAV 110. Although certain embodiments are described employing position-type and camera-type sensors for the purpose of explanation, embodiments may include and employ any suitable sensors or similar devices. For example, a UAV 110 tasked with a mission for detecting levels of radiation may be outfitted with a radiation detector type sensor.

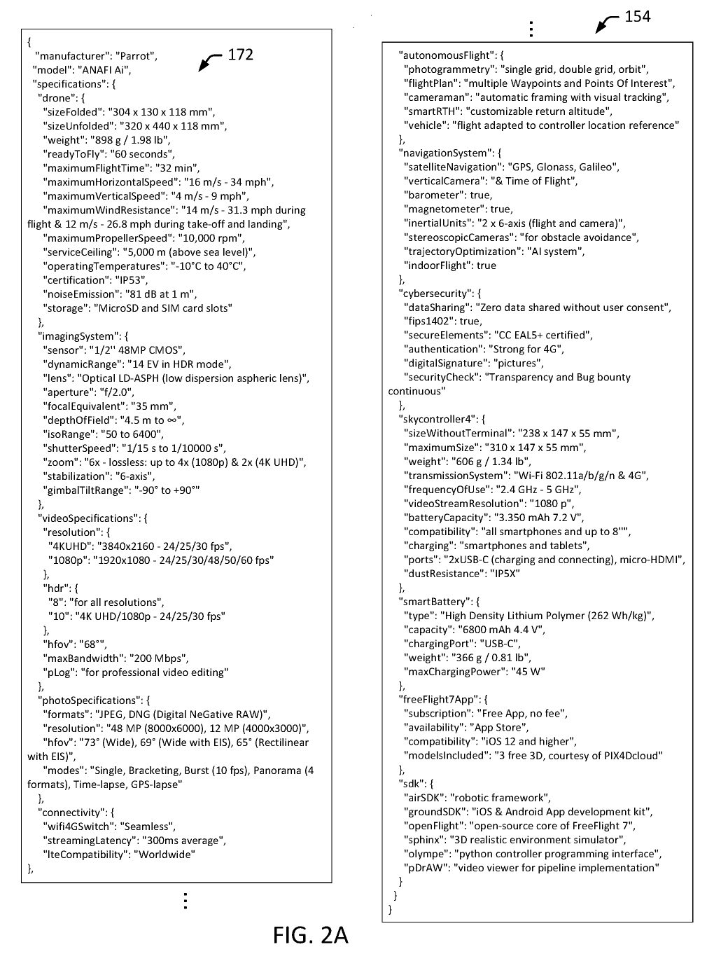

In some embodiments, UAV configuration data 154 defines operational characteristics of a UAV. For example, UAV configuration data 154 for UAV 110 may include UAV model information 172 for UAV 110 defining specifications and capabilities of UAV 110, a UAV command library 174 for UAV 110 defining available operational commands for UAV 110, or the like. UAV model information for a UAV may, for example, specify physical specifications, such as UAV weight and size, UAV capabilities, such as range, flight speed, flight ceiling, operating temperature range, noise emission, payload capabilities, such as specifications of an onboard camera, specifications of an onboard wireless communication system, or the like. FIGS. 2A and 2B are diagrams that illustrate an example set of UAV configuration data 154 in accordance with one or more embodiments. FIG. 2A illustrates an example set of UAV model information 172 of the example set of UAV configuration data 154 in accordance with one or more embodiments. FIG. 2B illustrates an example UAV command library 174 of the example set of UAV configuration data 154 in accordance with one or more embodiments. The illustrated UAV model information 172 may, for example, define specifications and capabilities of UAV 110. The illustrated UAV command library 174 may, for example, define available operational commands for UAV 110.

In some embodiments, UAV mission control system 112 is operable to coordinate inputs from various sources and generate corresponding UAV mission commands 164 for execution by UAV 110. For example, UAV mission control system 112 may receive inputs from user 104 (e.g., one or more spoken natural language requests 150 obtained by way of user input device 114), from data sources (e.g., textual map data 156 from mapping application 122 and supplemental data 160 from supplemental data sources 126) and from UAV 110 (e.g., UAV configuration data 154 from UAV 110 or its manufacturer), and generate, based on the inputs, corresponding UAV mission commands for execution by UAV 110.

In some embodiments, user input device 114 is an electronic device operable to exchange information with a user 104. For example, user input device 114 may be an electronic device, such as a computer, laptop computer, a tablet computer, mobile communications device, such as a smartphone, a UAV remote control, or the like. In some embodiments, user input device 114 includes a computer system that is the same or similar to that of computer system 1000 described with regard to at least FIG. 6.

In some embodiments, user interface (UI) 140 of user input device 114 provides an interface for interacting with user 104. For example, UI 140 may include a keyboard, a graphical user interface (e.g., a display), a microphone, a speaker, or the like. As described, a microphone may, for example, enable receipt of a natural language mission request 150 spoken by user 104. Similarly, a keyboard may, for example, enable receipt of a natural language mission request 150 typed-in by user 104. A speaker or display may, for example, provide for presenting information, such as audio or visual representations of response content 166 to user 104.

In some embodiments, speech module 144 of user input device 114 provides for translation of speech-to-text or text-to-speech. Speech module 144 may, for example, include a speech-to-text application that employs advanced algorithms (e.g., based on machine learning and deep learning techniques) to transcribe spoken words into textual format. Such an application may employ signal processing, feature extraction, and language modeling to interpret and convert audio signals into coherent textual content. As described, such speech-to-text conversion may be employed to translate words spoken by user 104 into a microphone of user input device 114 into textual data. Speech module 144 may, for example, include a text-to-speech application that converts written or text-based content into spoken language. In some embodiments, speech module 144 employs language translation to, for example, convert text and speech between different languages. As described, such text-to-speech conversion may be employed to convert textual data received into audible speech that is presented to user 104 by way of a speaker of user input device 114.

In some embodiments, location module 146 of user input device 114 provides for determining or reporting a geographic location of the user input device 114. Location module 146 may, for example, include a GPS receiver that communicates with satellites to determine precise location coordinates (e.g., geographic coordinates including latitude, longitude, and elevation). As described, such location information may be employed to determine the location of user input device 114 or user 104.

In some embodiments, controller 142 of user input device 114 provides for controlling operations of user input device 114, including the receipt, processing and transmission of data by user input device 114. For example, in response to receiving a spoken natural language mission request 150 by way of a microphone of UI 140 (e.g., a spoken request of “Fly UAV#1 over nearest XYZ convenience store and take pictures of roof of the store and return”), controller 142 may provide corresponding speech data to speech module 144 for translation from speech data to text data, and, in response to receiving the text data, generate corresponding request data 152 that includes the text data corresponding to the spoken natural language mission request 150 (e.g., request data 152 that includes text of “fly UAV number one over the nearest XYZ convenience store and take pictures of the roof of the store and return”) and location data 168 (e.g., geographic coordinates) corresponding to a location of user input device 114, user 104, or UAV 110 at the time of receiving the spoken natural language mission request 150. As another example, in response to receiving response content 166 (e.g., textual data “At what altitude would you like the photographs taken from?”), controller 142 may provide the textual data to speech module 144 for translation from text data to speech data, and, in response to receiving the speech data, employ a speaker of UI 140 to broadcast an audible message corresponding to the response content 166 (e.g., announce “At what altitude would you like the photographs taken from?”). Such a user input device 114 may enable exchange of information between user 104 and UAV mission control system 112 in a natural, conversational manner, simplifying the submission of initial and follow-up natural language mission request 150.

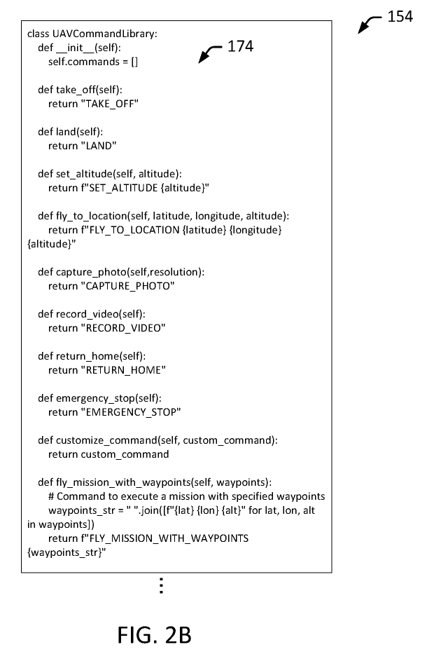

In some embodiments, mapping application 122 is operable to provide map data for a geographic region responsive to a query concerning the geographic region. For example, mapping application 122 may include a mapping application, such as OpenStreetMap (OSM), that is operable to provide a set of textual map data 156 for a given geographic region in response to a map request 157 that specifies the geographic region. In some embodiments, mapping application 122 is accessed by way of an application programming interface (API), such as an editing API of OpenStreetMap for fetching and saving raw geodata to and from the OpenStreetMap database. The textual map data 156 may, for example, be defined by text that defines a topological data structure, including data primitives, such as nodes, ways, relations, and tags. Nodes may include points with a geographic position, stored as coordinates (pairs of latitude and longitude) according to a world geodetic system (WGS), such as WGS 84. Nodes may be used to represent map features without a size, such as points of interest or mountain peaks. Ways may be ordered lists of nodes, representing a polyline, or a polygon if they form a closed loop. Ways may be used, for example, for representing linear features such as streets and rivers, and areas, like forests, parks, parking areas, and lakes. Relations may be ordered lists of nodes, ways and relations (together called “members”), where each member can optionally have a “role” (a string). Relations may be used for representing the relationship between existing nodes and ways. Examples of relations include turn restrictions on roads, routes that span several existing ways (e.g., a long-distance motorway), and areas with holes. Tags may be key-value pairs (e.g., both arbitrary strings). Tags may be used to store metadata about the map objects (such as their type, their name and their physical properties). Tags may not be freestanding but may be attached to an object: to a node, a way, or a relation. Textual map data 156 my include structured, unstructured or semi-structured map and geographic information system (GIS) data. FIG. 3 is a diagram that illustrates example textual map data 156 in accordance with one or more embodiments. In the illustrated embodiment, the <node> element represents a point on the map with a unique identifier (id) and geographical coordinates (lat for latitude and lon for longitude). The <tag> elements inside the <node> represent additional information about the point, such as its name (“Big Ben”) and amenity (“clock”). The <way> element represents a linear feature on the map, such as a road or path. It references the <node> elements that make up the way via <nd> elements and includes additional information using <tag> elements. The illustrated textual map data 156 of FIG. 3 is an example that demonstrates elements of textual map data. The elements of textual map data 156, e.g., provided by OpenStreetMap, for a given region could be more or less complex, and could include a vast amount of additional information, such as fly and no-fly zones, obstacles, points of interest, road networks, and the like.

In some embodiments, language model 124 is operable to generate UAV commands for a mission to be performed by UAV 110, based on model input data 158 that corresponds to a natural language mission request 150 concerning a UAV mission to be performed in a given geographic region, map data 156 retrieved for the given geographic region, and UAV configuration data 154 for the UAV 110, including UAV commands that are available for the UAV and model information for the UAV. Language model 124 may, for example, be a UAV large language model (LLM) that employs natural language processing (NLP), map data integration, UAV configuration data, mission planning algorithms, real-time feedback, safety protocols, flight restrictions, and adaptation. With regard to NLP, such an LLM may employ sophisticated NLP algorithms that allow it to comprehend and interpret user-provided natural language requests for UAV missions. This may include extracting mission objectives, waypoints, and specific requirements expressed in the user’s language. With regard to map data integration, such an LLM may employ map data retrieved for the specified region, enabling it to understand the geographical context of the mission. This may include details about terrain, landmarks, obstacles, and other relevant features that influence mission planning. With regard to UAV configuration data, such an LLM may be aware of the UAV’s capabilities and constraints through UAV configuration data 154, which may include information about a UAV’s sensors, communication systems, battery life, flight range, available commands, and so forth. This may ensure that the generated commands align with a target UAV’s capabilities. Regarding mission planning algorithms, such an LLM may utilizes advanced algorithms for mission planning, considering both user-provided objectives and the contextual information from map data, including textual map data 156. The LLM may, for example, account for factors like optimal flight paths, altitude adjustments, hover time, and location and sequencing of commands to achieve the specified mission goals. Regarding real-time feedback, such an LLM may provide real-time feedback (e.g., for presentation to user 104) during the command generation process. This feedback could include feasibility assessments, potential issues, or suggestions for optimizing the mission based on the UAV's capabilities and environmental conditions. As described, this may be transmitted and communicated to a user via response content, such as response content 166. Regarding safety protocols, such an LLM may incorporate safety protocols into the command generation process, ensuring that the UAV commands generated adhere to regulations, avoid collisions, and prioritize the safety of the target UAV and its surrounding environment. Regarding adaptation, such an LLM may adapt to dynamic situations, accommodating changes in mission requirements, unexpected obstacles, weather, air traffic, changes in fly/no-fly zones, or adjustments to the target UAV’s configuration. Such an LLM may, for example, provide alternative command sets based on different user inputs or evolving conditions. Such an LLM may act as an intelligent interface between user 104 and UAV 110, translating natural language mission requests 150 into actionable and context-aware UAV commands (e.g., model mission commands 162), optimizing mission planning, and enhancing the overall efficiency and safety of the operation of UAV 110.

In some embodiments, an employed LLM includes a collection of language models (or “agents”) that are each trained or optimized for specific mission tasks. For example, a mission LLM may include a flight path LLM that is trained to provide an appropriate flight path based on mission location requirements, an imaging LLM that is trained to provide an appropriate set of imaging settings (e.g., camera locations defined by position/orientation) based on mission imaging requirements, and so forth. In some embodiments, an employed LLM that interacts with a user is trained to respond to mission-centric language. For example, a mission LLM may be trained to monitor for mission language/keywords indicative of a desire to conduct a UAV mission, and, in response to sensing mission language/keywords indicative of a desire to conduct a UAV mission (not simply other conversational dialogue) employ other mission-related LLMs to further determine and inquire regarding the user’s desired UAV mission. In some embodiments, an employed LLM is trained to provide output in a suitable format. For example, a mission LLM may be trained to output descriptions and parameters of the mission in a syntax that is compatible with storage in a database, e.g., in a format that can be stored/retrieved in a database. As another example, a mission LLM may be trained to output UAV and sensor commands, or programming in a format compatible with the target UAV system. As another example, a mission LLM may be trained to output UAV and sensor commands or programming in format compatible with a target data source, such as a mapping application, supplemental data source, another language model, or the like. In some embodiments, an employed LLM is trained to provide information in a format that is suitable for commanding operation of the UAV. For example, a mission LLM may be trained to, in response to determining a location, express that location in terms of a waypoint defined by a heading and distance relative to a given point, such as a current location of the UAV.

0039] In some embodiments, supplemental data sources 126 provide supplemental data 160 that can be used by LM 124 in generating responses to model input data 158 and generating model mission commands 164. Supplemental data sources 126 may, for example, provide additional information that can influence mission planning and improve LM 124’s decision-making process. Supplemental data sources 126 may include, for example, weather information services, such as weather applications, flight information services, such as flight regulation authorities and air traffic control, environmental information services, such as environmental condition services, terrain and obstacle databases, satellite imagery databases, communication services, such as communication network controllers, or the like. Weather applications may, for example, provide real-time weather data and forecast data. Integrating real-time weather data from weather applications may provide information on current weather conditions, including temperature, wind speed, humidity, and precipitation, which may, for example, be helpful for assessing the feasibility and safety of UAV operations. Integrating forecast data, such as long-term and short-term weather forecasts, may help the language model anticipate changing conditions, allowing it to optimize mission planning based on predicted weather patterns. Flight regulation authorities may, for example, provide indications of no-fly zones, temporary flight restrictions (TFRs), or the like. Indications of no-fly zones may provide a level of collaboration with aviation authorities or regulatory databases that help the language model identify restricted areas, no-fly zones, or zones with special restrictions, which can help to ensure that generated UAV commands comply with relevant regulations and maintain safety and legal compliance. Indications of TFRs due to events or emergencies may help the language model ensure that generated UAV commands avoid airspace disruptions and adhere to real-time regulations. Air traffic control systems may, for example, provide indications of live air traffic data. Access to real-time air traffic data may help the language model avoid potential collisions or conflicts with other aircraft. Environmental condition services may provide indications of the environmental conditions of the region. For example, an environmental condition service may communicate with environmental sensors throughout the region to provide real-time data on localized environmental conditions, such as temperature variations, humidity levels, or specific hazards. Such information can help the language model understand the state of the environment and generate optimized flight plans and commands. Terrain and obstacle databases may, for example, provide indications of topography and obstacles. Topographical maps may be provided that include detailed terrain elevation data that can help the language model understand the geography of the region, which can be helpful for planning UAV missions over diverse landscapes. Obstacle databases may provide information about buildings, towers, and other obstacles that can help the language model optimize flight paths that avoid collisions. Satellite imagery databases may provide high-resolution satellite imagery of the region of the mission. Satellite imagery may, for example, provide the language model with additional context for mission planning, enabling the model to identify landmarks, changes in vegetation, or specific features within the region of operation. Communication network controllers may provide indications of network coverage and status. Such information on the status of communication networks, including cellular and radio frequencies, can help the language model generate flight plans that maintain reliable connectivity between a ground control station and the UAV. By leveraging these or other supplemental data sources 126, LM 124 may be more context-aware and capable of generating UAV model mission commands 162 that consider a broad range of factors, ultimately improving mission planning, safety, and overall effectiveness.

In some embodiments, LM 124 is operable to obtain data regarding other drone missions. For example, LM 124 may include inputs of mission data regarding UAV missions conducted by UAVs other than the target UAV 110, such as mission parameters, information collected from those missions, or the like. These may be missions that are planned to occur after a mission of a target UAV 110, occurring simultaneously with a mission of a target UAV 110, or that have occurred prior to a mission of a target UAV 110, or the like. In some embodiments, LM 124 is trained (e.g., which may include initial training of a new model, tuning of an existing model, or the like) using data from prior UAV mission, user activity, or the like. For example, LM 124 may be trained using historical and contextual data provided by user 104 in defining missions, data obtained in prior UAV missions, or the like, which can help LM 124 iteratively improve performance and avoid having to generate each mission from scratch. In some embodiments, LM 124 employs information regarding ongoing activity in a region corresponding to a mission. For example, LM 124 may obtain (e.g., from a supplemental data source 126) and employ information concerning an event (e.g., sporting event, crowd gathering, or the like) in a region where a mission is being conducted, to inform aspects of the mission, such as routing, rerouting, or the like. Such information may enable dynamic routing of UAV 110 that provides flexibility and responsiveness to developing conditions. In some embodiments, LM 124 employs information regarding current conditions in a region corresponding to a mission. For example, LM 124 may obtain (e.g., from a supplemental data source 126) and employ information concerning wireless communication networks (e.g., radio frequency (RF) communication availability, GPS availability, or the like) in a region of a mission to inform aspects of the mission, such as how to obtain/report data, how to track position and movement, or the like. Such information may enable dynamic communication and guidance that provide flexibility and responsiveness to environmental variations.

In some embodiments, UAV module 130 of UAV mission control application 121 of UAV mission controller 120 is operable to interact with UAV 110 or associated systems. For example, UAV module 130 may establish communication with UAV 110 and query UAV 110 for its UAV configuration data 154. In such an embodiment, UAV 110 may send to UAV module 130 its UAV configuration data 154, such as its location, flight status, battery power, UAV command library 174, its UAV model information 172, or the like. In some embodiments, UAV module 130 is operable to retrieve UAV configuration data 154 from external sources (e.g., sources other than UAV 110 itself). For example, UAV module 130 may determine a model and manufacturer of UAV 110 and, in response, query an external database or the manufacturer for configuration data 154, such as a UAV command library 174 or UAV model information 172 for UAV 110. In some embodiments, such as when UAV module 130 is unable to obtain complete UAV configuration data 154 for UAV 110, model input data 158 may include identification information for UAV 110, such as the model and manufacturer of UAV 110, and language model 124 may query a supplemental data source 126, such as the identified manufacturer of UAV 110, for configuration data 154 of the identified model of UAV 110, such as a UAV command library 174, UAV model information 172, or the like for the identified model of UAV 110. In some embodiments, UAV module 130 communicates UAV mission commands 164 to UAV 110. For example, UAV module 130 may receive model mission commands 162 from language module 132 and send, to a controller of UAV 110 (e.g., via wired or wireless communication protocol, such as Bluetooth or WiFi), corresponding UAV mission commands 164 (e.g., commands executable by the controller of UAV 110 to cause UAV 110 to fly to the location of the nearest XYZ convenience store, acquire photographs of the XYZ convenience store using its onboard camera, and fly home from the location of the XYZ convenience store). As described, in such an embodiment, the controller of UAV 110 may store the received UAV mission commands 164 (e.g., in a memory of UAV 110) and execute the UAV mission commands 164 to complete the associated mission.

In some embodiments, mapping module 134 of UAV mission control application 121 of UAV mission controller 120 is operable to communicate with mapping application 122. For example, mapping module 134 may receive, from language module 132, an indication of a geographic region to be mapped (e.g., a map request indicating a given location and a radius defining the region, a polygon defining a boundary of the region, or the like), and mapping module 134 may, in turn, generate a corresponding map request 157, including a geographic region 180 (e.g., a set of four points defining a rectangular region that includes the geographic region to be mapped) indicating the geographic region to be mapped that it sends to mapping application 122. As described, mapping application 122 may, in turn, provide map data 156 for the geographic region, such as textual data defining a topological data structure, including data primitives, such as nodes, ways, relations, and tags for the geographic region (e.g., textual map data 156 for the rectangular region defined by the geographic region 180). In some embodiments, a map request 157 includes mapping supplements 182. For example, a map request 157 may include mapping supplements 182, such as annotations, no-fly regions, or the like. In such an embodiment, map data 156 for the geographic region may incorporate mapping supplements 182. For example, where mapping supplements 182 include a radio tower feature defined by a given geographic location and a height, and a no-fly zone defined by a polygon defined by a set of geographic points, the map data 156 for the geographic region may incorporate into map data 156 that it would otherwise return, a radio tower feature at the given geographic location and having the specified height, along with a no-fly zone defined by a polygon corresponding to the set of geographic points. Specification and inclusion of mapping supplements may enable customization of map data 156 to reflect features that may not otherwise be provided in map data 156 generated by mapping application 122. For example, user 104 or UAV mission control application 121 may be able to effect insertion of supplemental data into textual map data 156 using mapping supplements 182.

In some embodiments, language module 132 of UAV mission controller 120 is operable to coordinate communications with language model 124. For example, language module 132 may receive request data 152 (e.g., including text of “fly UAV number one over the nearest XYZ convenience store and take pictures of the roof of the store and return” that corresponds to a natural language mission request 150 and geographic coordinates corresponding to a location of the user input device 114 at the time of receiving the spoken natural language mission request 150), determine based on the request data 152, a UAV 110 to be employed (e.g., “UAV#1”) and a corresponding geographic region (e.g., defined by the geographic coordinates and a radius), query UAV module 130 for UAV configuration data 154 for UAV 110 to be employed (e.g., for UAV model information 172 and a UAV command library 174 for UAV 110), query mapping module 134 for map data 156 for the corresponding geographic region (e.g., for textual map data 156 defining a topological data structure, including data primitives, such as nodes, ways, relations, and tags, for the geographic region), generate model input data 158 that includes or otherwise corresponds to request data 152, UAV configuration data 154 for UAV 110 to be employed, and map data 156 for the corresponding geographic region (e.g., model input data 158 that includes the text of “fly UAV number one over the nearest XYZ convenience store and take pictures of the roof of the store and return” that corresponds to a natural language mission request 150, geographic coordinates corresponding to a location of user device 114 at the time of receiving the spoken natural language mission request 150, UAV model information 172 and a UAV command library 174 for UAV 110, and textual map data 156 that defines a topological data structure, including data primitives, such as nodes, ways, relations, and tags, for geographic region 106), and provide the generated model input data 158 to language model 124 to effectuate a prompt for language model 124 to generate model mission commands 162 that correspond to the generated model input data 158. As described, language model 124 may process the model input data 158, query supplemental data sources 126, query language module 132 to provide user 104 with dialogue response content 166 to prompt user 104 for supplemental request data 152, or the like, and process the model input data 158 and supplemental data 160 (and any supplemental request data 152 responsive to the dialogue response content 166) to determine a set of model mission commands 162 (e.g., commands executable to cause UAV 110 to fly to the location of the nearest XYZ convenience store, acquire photographs of the XYZ convenience store using an onboard camera, and fly home from the location of the XYZ convenience store). In some embodiments, language module 132 provides a set of model mission commands 162 to UAV module 130 and, in turn, provides a corresponding set of UAV mission commands 162 to UAV 110. In some embodiments, UAV mission commands 162 may be the same or similar to model mission commands 162. In some embodiments, UAV module 130 may modify (e.g., reformat) UAV mission commands 162 to generate model mission commands 162 that are suitable for transmission to UAV 110.

FIG. 1B is a diagram that illustrates aspects of generating mission commands 162 in accordance with one or more embodiments. As illustrated, LM 124 may receive model input data 158 including, for example, request data 152, map data 156, UAV configuration data 154, supplemental data 160, state data 176, or corresponding data, and generate a corresponding set of model mission commands 162. For example, model input data 158 may include the following: request data 152 that includes text data corresponding to the spoken natural language mission request 150 (e.g., request data 152 that includes text of “fly UAV number one over the nearest XYZ convenience store and take pictures of the roof of the store and return”) and location data 168 (e.g., geographic coordinates) corresponding to a location of the user input device 114, the user 104, or the UAV 110 at the time of receiving the spoken natural language mission request 150; textual map data 156 that includes text defining a topological data structure, including data primitives, such as nodes, ways, relations, and tags, for geographic region 106 (e.g., a rectangular region including a 10-mile radius around the location of the user input device 114 at the time of receiving the spoken natural language mission request 150); UAV configuration data 154 that includes a UAV command library 174 and UAV model information 172 for UAV#1 (e.g., UAV 110); supplemental data 160 that is relevant to generating mission commands for geographic region 106 in which the corresponding UAV mission is to be performed, such as weather information, no-fly zones, or real-time flight data retrieved by LM 124 from respective ones of a weather application, a flight regulation authority, or an air traffic control system; and state data 176 that includes information about the current status, environment, and configuration of UAV 110 or related states, such as a context profile for UAV110 (e.g., most recent settings for the UAV 110, such as camera resolution, or the like), flight rules (e.g., maximum/minimum flight speed, flight ceiling, no-fly zones, maximum flight distance, or the like), or user data (e.g., preferences for user 104, past missions for user 104, or the like). State data 176 may, for example, be user specified or based on historical user selection. In such an embodiment, LM 124 may be prompted with the model input data 158 and generate a corresponding set of model mission commands 162 that are executable to executable by UAV 110 to cause UAV 110 to execute the mission (e.g., program instructions executable to cause UAV 110 to fly (e.g., within maximum/minimum flight speed and below the flight ceiling) along a first portion of a flight path 170 (e.g., that routes around the no-fly zones) to the location of the nearest XYZ convenience store, acquire photographs of the XYZ convenience store using an onboard camera (e.g., at the camera resolution specified in the context profile), and fly (e.g., within maximum/minimum flight speed and below the flight ceiling) home from the location of the XYZ convenience store along a second portion of flight path 170 (e.g., which routes around the no-fly zones)).

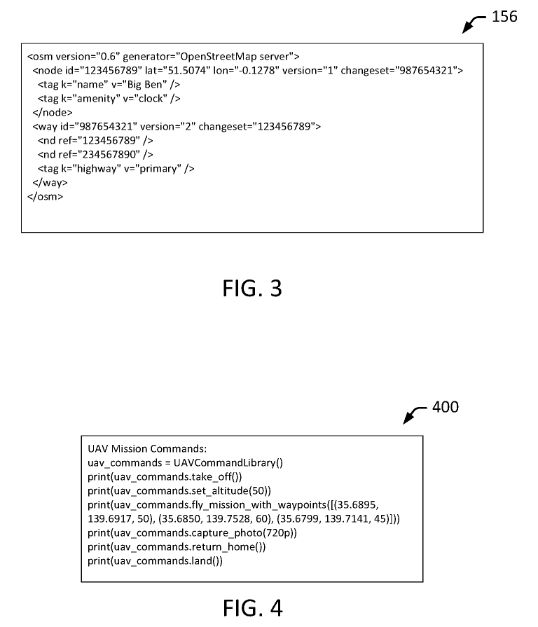

FIG. 4 is a diagram that illustrates example UAV mission commands 400 in accordance with one or more embodiments. In the illustrated embodiment, UAV mission commands 400 include commands to cause a UAV to take off, fly at an altitude of 50 meters along a flight path 170 defined by multiple waypoints, capture a photo at a resolution of 720p, return home, and land. The altitude and waypoints may, for example, define a flight path 170 that adheres to flight rules and avoids no fly zones or other areas of potential interference, such as a radio tower, power lines, a building, a mountain, or the like. Model mission commands 162 or UAV mission commands 164 may, for example, be the same or similar to UAV mission commands 400. The illustrated UAV mission commands 400 of FIG. 4 are provided as an example to demonstrate elements of UAV mission commands. The elements of UAV mission commands could be more or less complex, include a vast amount of additional flight elements, waypoints, tasks, or the like, be in a specific format that could, for example, be unique to a particular UAV, or the like.

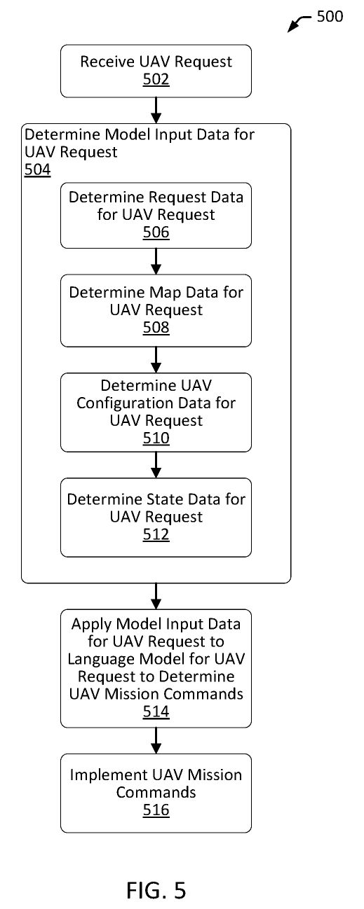

FIG. 5 is a flowchart diagram that illustrates a method 500 of defining and implementing a UAV mission in accordance with one or more embodiments. Some or all of the procedural elements of method 500 may be performed, for example, by UAV mission controller 120 or another entity.

Method 500 may include receiving a UAV request (block 502). This may include receiving a request corresponding to a natural language mission request concerning a mission for a UAV to be conducted in a given geographic region. For example, receiving a UAV request may include language module 132 of UAV mission controller 120 receiving, from a user input device 114, request data 152 that includes the text data corresponding to the spoken natural language mission request 150 (e.g., receiving request data 152 that includes text of “fly UAV number one over the nearest XYZ convenience store and take pictures of the roof of the store and return”) and location data 168 (e.g., geographic coordinates) corresponding to a location of user input device 114, user 104, or UAV 110 at the time of receiving the spoken natural language mission request 150.

Method 500 may include determining model input data for a UAV request (block 504), This may include determining model input data corresponding to a natural language mission request. Continuing with the prior example, determining model input data for a UAV request may include language module 132 of UAV mission controller 120 determining model input data 158 corresponding to a spoken natural language mission request 150 of “Fly UAV#1 over the nearest XYZ convenience store and take pictures of the roof of the store and return” submitted by user 104 via user input device 114.

As illustrated, in some embodiments, determining model input data for a UAV request (block 504) may include determining request data for a UAV request (block 506), determining map data for a UAV request (block 508), determining UAV configuration data for a UAV request (block 510), or determining state data for a UAV request (block 512).

Determining request data for a UAV request (block 506) may include determining a set of request data that corresponds to a natural language mission request. Continuing with the prior example, determining request data for a UAV request may include language module 132 of UAV mission controller 120 determining request data 152 that includes text of “fly UAV number one over the nearest XYZ convenience store and take pictures of the roof of the store and return” and location data 168 (e.g., geographic coordinates) corresponding to a location of user input device 114, user 104, or UAV 110 at the time of receiving the spoken natural language mission request 150.

Determining map data for a UAV request (block 508) may include determining a set of map data that corresponds to request data 152. Continuing with the prior example, determining map data for a UAV request may include language module 132 of UAV mission controller 120 determining a set of textual map data 156 for a geographic region that corresponds to the UAV request. This may include mapping module 134 receiving, from language module 132, an indication of a geographic region to be mapped (e.g., indicating a given location and a radius, a polygon defining a boundary of the region, or the like), and mapping module 134, in turn, generating a corresponding map request 157, including an indication of the geographic region to be mapped, that it sends to mapping application 122. Mapping application 122 may, in turn, return map data 156 for the geographic region, such as text defining a topological data structure, including data primitives, such as nodes, ways, relations, and tags, for the geographic region (e.g., a region including the area within the radius of the given location, the polygon, or the like). Mapping module 134 may receive map data 156 (e.g., the textual data) and forward the map data 156 to language module 132, which may determine that data to be the map data 156 for the associated UAV request.

Determining UAV configuration data for a UAV request (block 510) may include determining a set of UAV configuration data for a UAV for performing the UAV request. Continuing with the prior example, determining UAV configuration data for a UAV request may include language module 132 of UAV mission controller 120 obtaining UAV configuration data 154, including UAV model information 172 and a UAV command library 174 for UAV 110. This may include, UAV module 130 receiving an indication of UAV 110 from language module 132 and, in turn, querying UAV 110 (or another source) for UAV configuration data 154, including UAV model information 172 and a UAV command library 174 for UAV 110, and returning the obtained UAV configuration data to language module 132, which may determine that data to be the UAV configuration data 154 for the associated UAV request.

Determining state data for a UAV request (block 512) may include determining a set of state data defining the current status, environment, and configuration of UAV 110 or related states, such as states indicative of user preferences or history. Continuing with the prior example, determining state data for a UAV request may include language module 132 of UAV mission controller 120 obtaining state data 176 that includes information about the current status, environment, and configuration of UAV 110 or related states, such as a context profile for UAV110 (e.g., most recent settings for UAV 110, such as camera resolution, or the like), flight rules (e.g., maximum/minimum flight speed, flight ceiling, no-fly zones, or the like), or user data (e.g., preferences for user 104, past missions for user 104, or the like). Language module 132 may determine that data to be the state data 176 for the associated UAV request.

Accordingly, determining model input data for a UAV request may include, for example, model input data 158 that includes request data 152 that includes the following: (a) request data 152 that includes text of “fly UAV number one over nearest XYZ convenience store and take pictures of roof of the store and return”) and location data 168 (e.g., geographic coordinates) corresponding to a location of user input device 114, user 104, or UAV 110 at the time of receiving the spoken natural language mission request 150; (b) map data 156 for the geographic region (e.g., a region including the area within the radius of the given location, the polygon, or the like), such as text defining a topological data structure, including data primitives, such as nodes, ways, relations, and tags, for the geographic region; (c) UAV configuration data 154 including UAV model information 172 and a UAV command library 174 for UAV 110; and (d) state data 176 that includes information about the current status, environment, and configuration of UAV 110 or related states, such as a context profile for UAV110 (e.g., most recent settings for UAV 110, such as camera resolution, or the like), flight rules (e.g., maximum/minimum flight speed, flight ceiling, no-fly zones, or the like), or user data (e.g., preferences for user 104, past missions for user 104, or the like).

Method 500 may include applying model input data for a UAV request to language model to determine UAV mission commands (block 514). This may include applying model input data corresponding to a UAV request to an LLM to determine UAV mission commands corresponding to the UAV request. Continuing with the prior example, applying model input data for a UAV request to a language model to determine UAV mission commands may include language module 132 of UAV mission controller 120 prompting language model 124 with model input data 158 (e.g., including request data 152, map data 156, UAV configuration data 154, and state data 176, and language model 124 generating, based on model input data 158, model mission commands 162 corresponding to spoken natural language mission request 150 of “Fly UAV#1 over the nearest XYZ convenience store and take pictures of the roof of the store and return” submitted by user 104 via user input device 114. The model mission commands 162 may include, for example, a set of commands that are executable to cause UAV 110 to execute the mission, such as program instructions executable by a processor of UAV 110 to cause UAV 110 to fly (e.g., within a specified maximum/minimum flight speed and below a specified flight ceiling of 50 meters) along a first portion of a flight path 170 (e.g., which routes around specified no-fly zones) to the location of the nearest XYZ convenience store, acquire photographs of the nearest XYZ convenience store using an onboard camera (e.g., at a specified image resolution of 720p), and fly (e.g., within the specified maximum/minimum flight speed and below the specified flight ceiling of 50 meters) home from the location of the XYZ convenience store along a second portion of flight path 170 (e.g., which routes around the specified no-fly zones)).

Method 500 may include implementing UAV mission commands (block 516). This may include executing UAV mission commands to complete an associated UAV mission that services a corresponding UAV request. Continuing with the prior example, implementing UAV mission commands may include language module 132 of UAV mission controller 120 receiving model mission commands 162 output by language model 124, language module 132 forwarding model mission commands 162 to UAV module 130 of UAV mission controller 120, and UAV module 130 transmitting, to UAV 110, a set of UAV mission commands 164 corresponding to model mission commands 162 (e.g., the UAV mission commands 164 may be the same or similar to the model mission commands 164). A processor of UAV 110 may, for example, store the UAV mission commands 164 in a memory of UAV 110, and execute the UAV mission commands 164 to cause UAV 110 to fly (e.g., within a specified maximum/minimum flight speed and below a specified flight ceiling of 50 meters) along a first portion of a flight path 170 (e.g., which routes around specified no-fly zones) to the location of the nearest XYZ convenience store, acquire photographs of the nearest XYZ convenience store using an onboard camera (e.g., at a specified image resolution of 720p), and fly (e.g., within the specified maximum/minimum flight speed and below the specified flight ceiling of 50 meters) home from the location of the XYZ convenience store along a second portion of flight path 170 (e.g., which routes around the specified no-fly zones)).

FIG. 6 is a diagram that illustrates an example computer system (or “system”) 1000 in accordance with one or more embodiments. System 1000 may include memory 1004, processor 1006, and an input/output (I/O) interface 1008. Memory 1004 may include non-volatile memory (e.g., flash memory, read-only memory (ROM), programmable read-only memory (PROM), erasable programmable read-only memory (EPROM), electrically erasable programmable read-only memory (EEPROM)); volatile memory (e.g., random access memory (RAM), static random access memory (SRAM), synchronous dynamic RAM (SDRAM)); or bulk storage memory (e.g., CD-ROM or DVD-ROM, hard drives). Memory 1004 may include a non-transitory computer-readable storage medium having program instructions 1010 stored on the medium. Program instructions 1010 may include program modules 1012 that are executable by processor 1006 (e.g., processor 1006) to cause the functional operations described, such as those described with regard to the entities (e.g., user 104, user input device 114, UAV mission controller 120, UAV mission control application 121, mapping application 122, language model 124, supplemental data sources, UAV 110, or the like) or method 500.

Processor 1006 may be any suitable processor capable of executing program instructions. Processor 1006 may include one or more processors that carry out program instructions (e.g., program instructions of program modules 1012) to perform arithmetical, logical, and input/output operations described. Processor 1006 may include multiple processors that can be grouped into one or more processing cores each containing a group of one or more processors used for executing the processing described herein, such as independent parallel processing of partitions (or “sectors”) by different processing cores to generate a simulation of a reservoir. I/O interface 1008 may provide an interface for communication with one or more I/O devices 1014, such as a joystick, a computer mouse, a keyboard, or a display screen (e.g., an electronic display for displaying a graphical user interface (GUI)). I/O devices 1014 may include one or more user input devices. I/O devices 1014 may be connected to I/O interface 1008 by way of a wired connection (e.g., an Industrial Ethernet connection) or a wireless connection (e.g., a Wi-Fi connection). I/O interface 1008 may provide an interface for communication with one or more external devices 1016, computer systems, servers, or electronic communication networks. In some embodiments, I/O interface 1008 includes an antenna or a transceiver. Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. An unmanned aerial vehicle (UAV) system comprising:
a user device comprising a user interface; and
a UAV mission controller;
the user device configured to:
receive, from a user, a spoken request comprising a natural language mission request concerning a mission for a UAV to be conducted in a given geographic region;
generate request data corresponding to the natural language mission request; and
send, to the UAV mission controller, the request data,
the UAV mission controller configured to:
determine, in response to receiving the request data, the given geographic region;
send, to a mapping application, a request for textual map data for the given geographic region;
receive, from the mapping application, the textual map data for the given geographic region;
obtain UAV configuration data indicative of capabilities of the UAV;
send, to a UAV large language model (LLM), model input data corresponding to the natural language mission request, the textual map data, and the UAV configuration data, the UAV LLM configured to generate, based on the model input data, model mission commands for the mission;
receive, from the UAV LLM, the model mission commands for the mission;
determine, based on the model mission commands for the mission, UAV mission commands for the UAV; and
send, to the UAV, the UAV mission commands, the UAV configured to execute the UAV mission commands to conduct the mission.

2. The system of claim 1, wherein the UAV LLM is configured to obtain, from supplemental data sources, supplemental data concerning operation of the UAV in the given geographic region, and wherein the model mission commands for the mission are generated based on the supplemental data.

3. An unmanned aerial vehicle (UAV) system comprising:
a UAV mission controller configured to:
receive, from a user by way of a user interface of a user device, a natural language mission request concerning a mission for a UAV to be conducted in a given geographic region;
obtain, from a mapping application, textual map data for the given geographic region;
obtain UAV configuration data indicative of capabilities of the UAV;
provide, to a language model (LM), model input data corresponding to the natural language mission request, the textual map data, and the UAV configuration data, the LM configured to generate, based on the model input data, model mission commands for the mission;
receive, from the LM, the model mission commands for the mission; and
send, to the UAV, UAV mission commands corresponding to the model mission commands for the mission.

4. The system of claim 3, wherein the UAV is configured to execute the UAV mission commands to conduct the mission.

5. The system of claim 3, wherein the LM is configured to obtain, from supplemental data sources, supplemental data concerning operation of the UAV in the given geographic region, and wherein the model mission commands for the mission are generated based on the supplemental data.

6. The system of claim 5, wherein the supplemental data sources comprise a weather information service and the supplemental data comprises weather data for the given geographic region.

7. The system of claim 5, wherein the supplemental data sources comprise a flight information service and the supplemental data comprises flight data for the given geographic region.

8. The system of claim 3, wherein the user device comprises a location module configured to determine a location of the user device, wherein UAV mission controller is further configured to:
obtain device location data corresponding to a location of the user device determined by way of the location module; and
determine the given geographic region based on the device location data.

9. The system of claim 3, wherein UAV mission controller is further configured to:
determine supplemental request data to be provided by the user, and
send, to the user device, dialogue response content requesting the supplemental request data, wherein the user device is configured to present the dialogue response content by way of the user interface and obtain the supplemental request data by way of the user interface, wherein the model input data further corresponds to the supplemental request data.

10. The system of claim 3, wherein the UAV configuration data comprises a UAV command library that defines available commands for the UAV.

11. The system of claim 3, wherein the UAV configuration data comprises UAV model information for the UAV.

12. A method for unmanned aerial vehicle (UAV) control comprising:
receiving, by a UAV mission controller from a user by way of a user interface of a user device, a natural language mission request concerning a mission for a UAV to be conducted in a given geographic region;
obtaining, by the UAV mission controller from a mapping application, textual map data for the given geographic region;
obtaining, by the UAV mission controller, UAV configuration data indicative of capabilities of the UAV;
providing, by the UAV mission controller to a language model (LM), model input data corresponding to the natural language mission request, the textual map data, and the UAV configuration data, the LM configured to generate, based on the model input data, model mission commands for the mission;
receiving, by the UAV mission controller from the LM, the model mission commands for the mission; and
sending, by the UAV mission controller to the UAV, UAV mission commands corresponding to the model mission commands for the mission.

13. The method of claim 12, further comprising executing, by the UAV, the UAV mission commands to conduct the mission.

14. The method of claim 12, wherein the LM obtains, from supplemental data sources, supplemental data concerning operation of the UAV in the given geographic region, and wherein the model mission commands for the mission are generated based on the supplemental data.

15. The method of claim 14, wherein the supplemental data sources comprise a weather information service and the supplemental data comprises weather data for the given geographic region.

16. The method of claim 14, wherein the supplemental data sources comprise a flight information service and the supplemental data comprises flight data for the given geographic region.

17. The method of claim 12, wherein the user device comprises a location module configured to determine a location of the user device, the method further comprising:
obtaining, by the UAV mission controller, device location data corresponding to a location of the user device determined by way of the location module; and
determining, by the UAV mission controller, the given geographic region based on the device location data.

18. The method of claim 12, further comprising:
determining, by the UAV mission controller, supplemental request data to be provided by the user, and
sending, by the UAV mission controller to the user device, dialogue response content requesting the supplemental request data, wherein the user device is configured to present the dialogue response content by way of the user interface and obtain the supplemental request data by way of the user interface, wherein the model input data further corresponds to the supplemental request data.

19. The method of claim 12, wherein the UAV configuration data comprises a UAV command library that defines available commands for the UAV.

20. The method of claim 12, wherein the UAV configuration data comprises UAV model information for the UAV.

21. Non-transitory computer-readable storage medium comprising program instructions stored thereon that are executable by a processor to cause the following operations for unmanned aerial vehicle (UAV) control:
receiving, by a UAV mission controller from a user by way of a user interface of a user device, a natural language mission request concerning a mission for a UAV to be conducted in a given geographic region;
obtaining, by the UAV mission controller from a mapping application, textual map data for the given geographic region;
obtaining, by the UAV mission controller, UAV configuration data indicative of capabilities of the UAV;
providing, by the UAV mission controller to a language model (LM), model input data corresponding to the natural language mission request, the textual map data, and the UAV configuration data, the LM configured to generate, based on the model input data, model mission commands for the mission;
receiving, by the UAV mission controller from the LM, the model mission commands for the mission; and
sending, by the UAV mission controller to the UAV, UAV mission commands corresponding to the model mission commands for the mission.
